(19) United States
(12) Patent Application Publication
(10) Pub. No.: US 2004/0164149 A1
(43) Pub. Date: Aug. 26, 2004

(54) Method and system for providing consumer-level off-site data storage

(76) Inventor: James A. Roberts, Cranford, NJ (US)

Correspondence Address: DITTHAVONG & CARLSON, P.C., Suite A, 10507 Braddock Road, Fairfax, VA, 22032, US

(21) Appl. No.: 10/775,569

(22) Filed: Feb. 10, 2004

Related U.S. Application Data
(60) Provisional application No. 60/446,673, filed on Feb. 11, 2003.

(51) Int. Cl. G06F 17/60

(52) U.S. Cl. 235/385

(57) ABSTRACT

An approach for providing consumer-level off-site data storage for electronic media is disclosed. A tracking system can be deployed at a retailer location for receiving and tracking deposited electronic media by customers, who are consumer-level users (i.e., residential or small office users). The tracking system generates unique identifiers (e.g., barcodes) associated with the physical media in response to input information about the physical media and an owner of the physical media. The physical media is stored according to one of the unique identifiers that specify location of the physical media within a storage facility of a storage provider.

### RELATED APPLICATION

This application is related to, and claims the benefit of the earlier filing date under 35 U.S.C. § 119(e) of, U.S. Provisional Patent Application (Serial No. 60/446,673) filed Feb. 11, 2003, entitled “Method and System for Providing Consumer-Level Off-Site Data Storage”; the entirety of which are incorporated herein by reference.

### FIELD OF THE INVENTION

The present invention relates to storage of media and more particularly to storing and tracking of electronic media for residential and small business consumers.

### BACKGROUND OF THE INVENTION

The pervasiveness of home and small office computing has resulted in the generation of mass quantities of data for residential or small office users (i.e., consumer-level users). The data storage requirements for these consumer-level users stem, in part, from multi-media content, and data associated with productivity tools, for example, spreadsheets, tax programs, financial management programs, and family historical documents (e.g., photos, birth certificates, insurance information, etc.). However, unlike large businesses, residential and small office users cannot feasibly invest in sophisticated, expensive data processing systems, such as data centers or distributed database systems, to address their off-site data storage requirements. Consequently, the typical residential user confronts the problems of potential data loss through household hazards and disorganization.

One alternative for the consumer-level users is to store their electronic media off-site in a general storage facility. However, these general physical storage facilities cannot address the issues of disorganization, as it is likely that the users will pack the diskettes and Compact Discs (CDs) in a box along with other items. This approach does not provide an effective way to track the contents of the electronic media. Additionally, a general storage facility seldom provides a climate-controlled environment, which is required to ensure that the diskettes and CDs are not damaged by the heat and/or humidity.

Another drawback with this approach is the cost; general storage facilities traditionally require renting a fixed amount of space, such as an entire room. This cost is too high, particularly, if the consumer-level user seeks to store only a few CDs of important financial data. Yet another drawback concerns convenience; these general storage facilities are not usually conveniently located, given the fact that they require a vast amount of physical space, thereby are traditionally situated in rural or inconvenient areas.

Therefore, there is a need for an approach for consumer-level users to conveniently and economically store electronic media off-site.

### SUMMARY OF THE INVENTION

Convenience, expense, and other needs are addressed by the present invention, in which an approach is provided for supporting off-site data storage of electronic media at a consumer-level. According to one embodiment of the present invention, a tracking system is deployed at a retailer location for receiving and tracking deposited electronic media by customers, who are residential or small office users. This arrangement advantageously addresses the recognized need for providing viable consumer-level off-site data storage, and enables the storage provider to gain a new source of revenue.

According to one aspect of the present invention, a method for providing storage services at a retailer facility that sells consumer products is disclosed. The method includes receiving a physical media from a consumer, wherein the physical media stores content imparted by the consumer. Also, the method includes generating a first identifier for identifying the consumer, and a second identifier for specifying location of the physical media within the retailer facility. The method also includes storing the physical media at the location according to the second identifier. Further, the method includes charging the consumer for storage of the physical media.

According to another aspect of the present invention, a tracking system for supporting storage services at a retail establishment that includes a storage facility is disclosed. The system includes a processor configured, in response to receiving a physical media from a consumer, to generate a first identifier for identifying the consumer, and a second identifier for specifying location of the physical media within the retailer facility. The system also includes a database configured to store the generated identifiers. The storage facility stores the physical media at the location according to the second identifier. The consumer is charged for storage of the physical media.

According to yet another aspect of the present invention, a computer-readable medium carrying one or more sequences of one or more instructions for providing storage services at a retailer facility that sells consumer products is disclosed. The one or more sequences of one or more instructions including instructions which, when executed by one or more processors, cause the one or more processors to perform the step of receiving a physical media from a consumer, wherein the physical media stores content imparted by the consumer. Other steps include generating a first identifier for identifying the consumer, and a second identifier for specifying location of the physical media within the retailer facility, and storing the physical media at the location according to the second identifier. Another step includes charging the consumer for storage of the physical media.

Still other aspects, features, and advantages of the present invention are readily apparent from the following detailed description, simply by illustrating a number of particular embodiments and implementations, including the best mode contemplated for carrying out the present invention. The present invention is also capable of other and different embodiments, and its several details can be modified in various obvious respects, all without departing from the spirit and scope of the present invention. Accordingly, the drawings and descriptions are to be regarded as illustrative in nature, and not as restrictive.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a diagram of a system for storing and tracking electronic media deposited by a consumer-level user, according to an embodiment of the present invention;

FIGS. 2a and 2b are a flowchart of a process for storing and tracking electronic media deposited at an electronic media storage provider site in the system of FIG. 1;

FIG. 3 is a flowchart of a process for a consumer-level user to retrieve the stored electronic media in the system of FIG. 1; and

FIG. 4 is a diagram of a computer system that can be used to implement an embodiment of the present invention.

### DESCRIPTION OF THE PREFERRED EMBODIMENT

An approach for tracking stored electronic media for a consumer-level user (i.e., residential or small office user) is described. In the following description, for the purposes of explanation, numerous specific details are set forth in order to provide a thorough understanding of the present invention. It is apparent, however, to one skilled in the art that the present invention may be practiced without these specific details or with an equivalent arrangement. In other instances, well-known structures and devices are shown in block diagram form in order to avoid unnecessarily obscuring the present invention.

### Off-Site Data Storage System

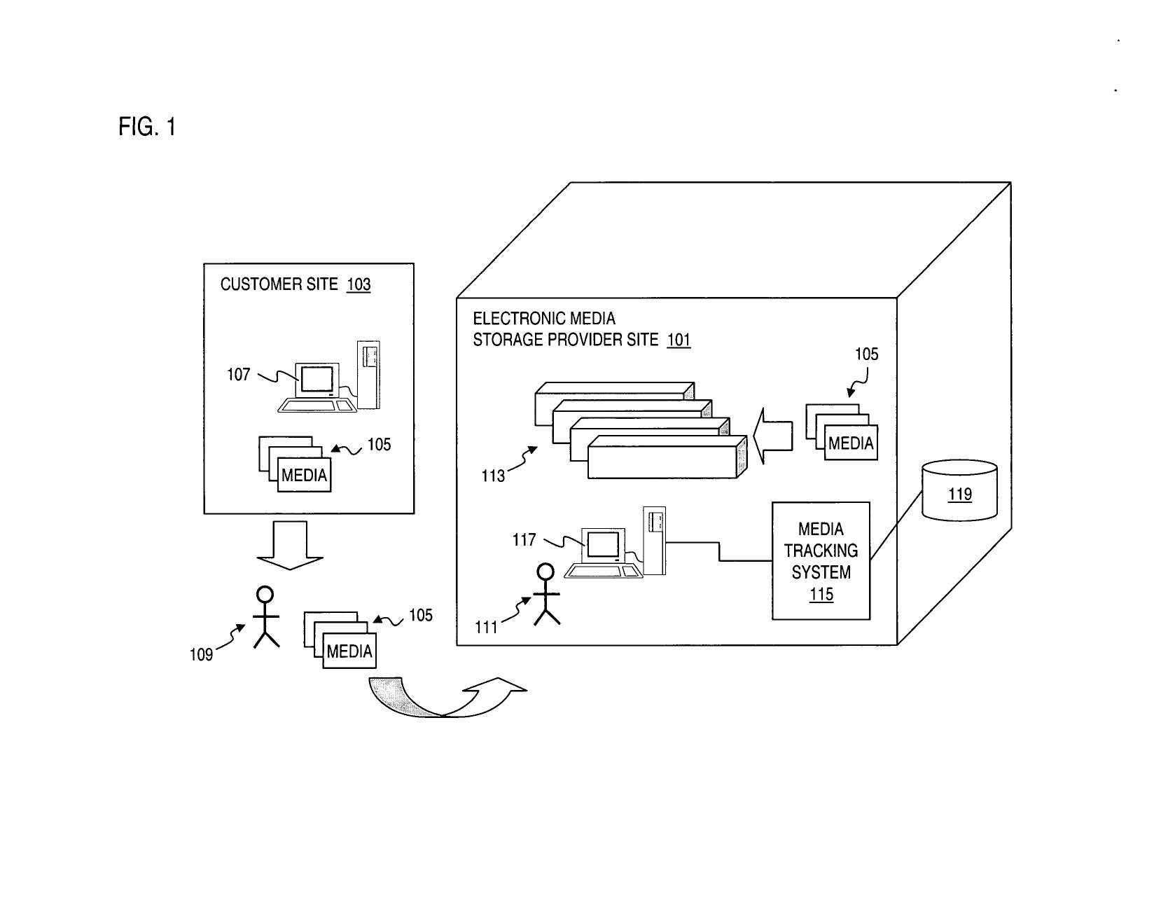

FIG. 1 is a diagram of a system for storing and tracking electronic media deposited by a consumer-level user, according to an embodiment of the present invention. An electronic media storage provider site 101 serves a number of customer sites 103, which can be residences or small business offices. At the site 103, electronic media 105 is generated by a computing system 107, which can include web appliances, PDAs (Personal Digital Assistants), desktop computers, laptop computers, and etc. The electronic media 105 can be any type of storage medium: Compact Discs (CDs), ZIP disks, hard drives, diskettes, flash memory cards, or other non-volatile memory devices. The storage provider site 101, in an exemplary embodiment, is deployed in a retail location to maximize convenience and availability to customers 109. Under this approach, the benefits of off-site data storage can be readily extended to the consumer level by using the resources of existing infrastructure; for example, a large retailer: Wal-Mart®, Target®, etc. While larger retail locations are suitable for both receiving and storing electronic data, locations with limited floor space, such as in urban areas, may be prohibitively expensive to store data. As an alternative, the consumer could carry in the electronic media to a receiving center where it is shipped or mailed to a central storage location.

A retail location, such as Wal-Mart® or Target®, is well staffed with personnel 111 and has a large amount of floor space (e.g., 100,000 ft²) that can be modified to accommodate counter space for receipt of the media 105 and a permanent storage facility (i.e., storage receptacle) 113 for storing the media 105. According to one embodiment of the present invention, the area and infrastructure of the permanent storage facility 113 is augmented with additional security, fire suppression and external power.

As seen in FIG. 1, the storage provider site 101 supports the storage of the media through a media tracking system 115, which communicates with a terminal 117 and a database 119 that stores information about the media 105. This information includes unique identifiers for the media 105, and location of the media 105 within the facility 113, as well as identification information of the customer 109 who owns the media 105.

### Process for Tracking and Storage of Media

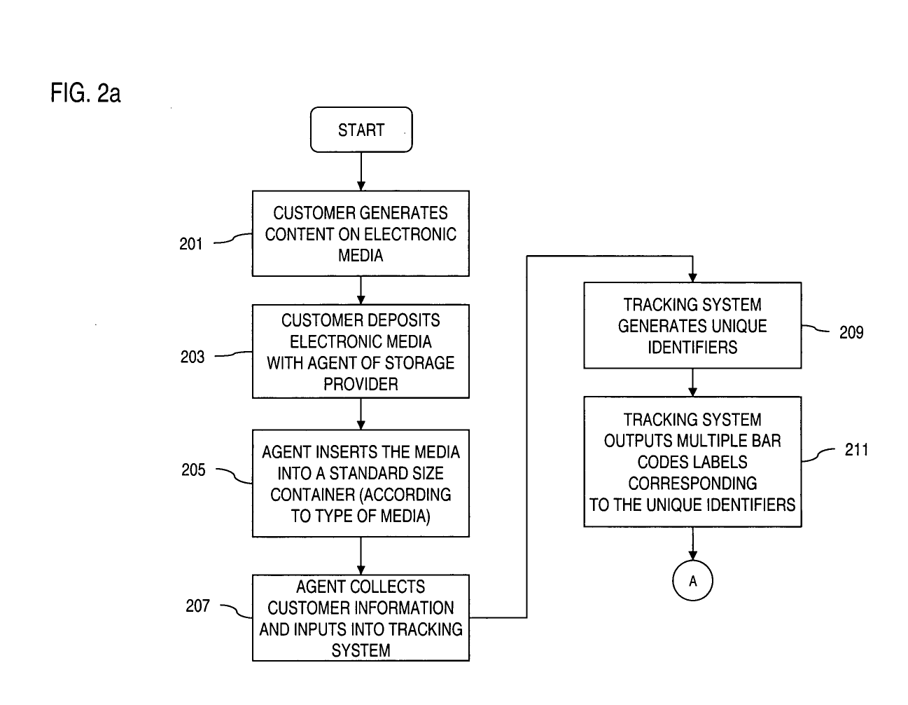

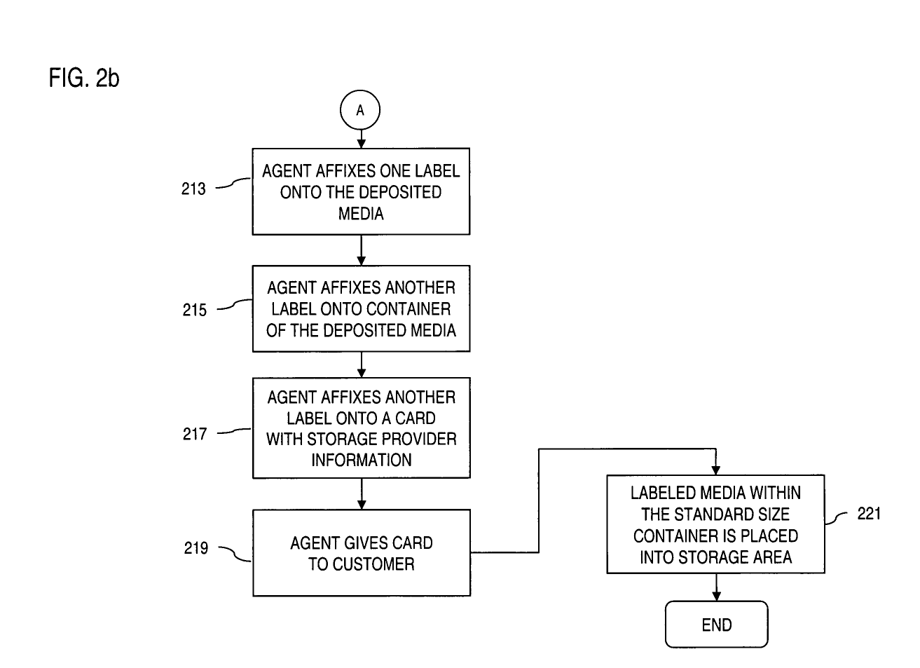

FIGS. 2a and 2b are a flowchart of a process for storing and tracking electronic media deposited at an electronic media storage provider site in the system of FIG. 1. In step 201, a customer 109 uses the computing system 107 to generate content that is stored on electronic media 105. To avoid data loss and prevent clutter at the customer site 103, the customer 109 brings in electronic media 105 to the storage provider site 101. Under the embodiment in which the provider site 101 is a retailer, if the customer 109 needs to visit the retailer for other purposes, the customer 109 can efficiently consolidate errands by visiting one location.

Upon arriving at the storage provider site 101, the customer 109 deposits the media with an agent 111 of the storage provider, as in step 203. Next, in step 205, the agent 111 (e.g., receiving counter person) inserts the media 105 into an appropriate sleeve or container, which varies depending on the size of the media 105. The sleeve or container is designed to maximize storage efficiency and traceability within the storage facility 113.

In step 207, the agent 111 asks the customer 109 questions to collect information about the customer, and inputs the customer information into the tracking system 115 via the terminal 117. As used herein, the customer information can include customer contact and media information. While the customer information can be integrated into the general network of the storage provider, a separate network can be designated expressly for the purpose of maintaining this information (i.e., customer contact and media information).

At this point, the tracking system 115 generates unique identifiers for the deposited media 105 in response to the input customer information, per step 209. According to one embodiment of the present invention, each piece of media 105 can be associated with two unique barcode numbers, one that identifies the owner of the media 105 and the other to identify the location within the storage receptacle 113. In an exemplary embodiment, these unique identifiers are output as barcodes onto barcode labels (step 211).

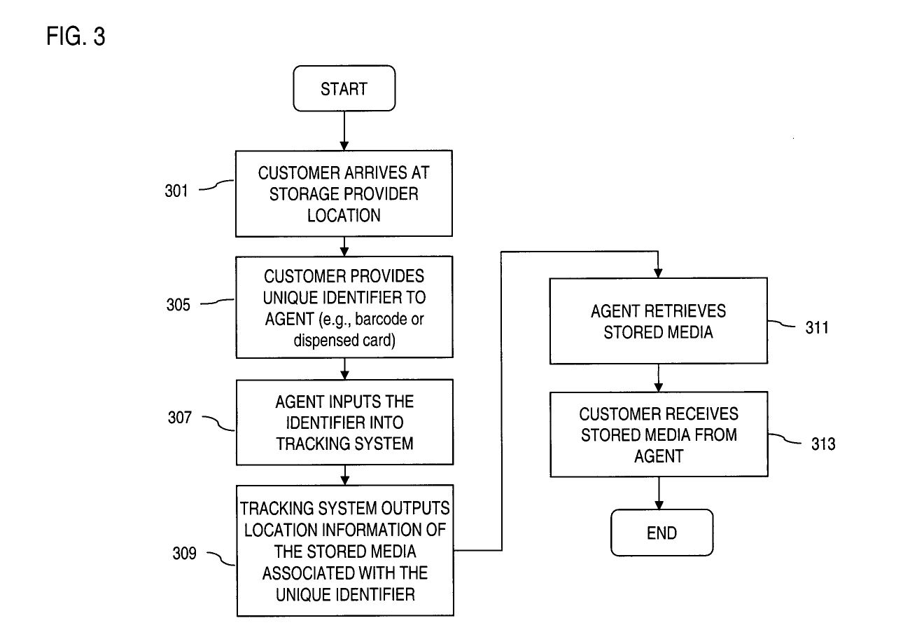

For example, three barcode labels, which reflect the generated unique identifiers, are produced by the tracking system 115. The agent 111 affixes one barcode label onto the media 105, as in step 213. In step 215, the agent 111 places another barcode label on the outer sleeve or container, sealing the packaging. Also, the agent 111 attaches the third barcode label onto a card (e.g., 2×3 business card) or receipt, per step 217, and presents the card to the customer 109 for safe keeping (step 219). The customer 109 can use the card or the information contained thereon to retrieve the stored media 105; this process is described later with respect to FIG. 3.

In step 221, the agent 111 places the labeled media into the final storage location, i.e., storage facility 113, which has a barcoded receptacle for storing the media 105.

The above approach advantageously provides a convenient off-site data storage capability for consumers, while providing an attractive business option for existing retailers. The storage provider can develop a pricing model, for example, based on the size of the media and the frequency of pickups and drop-offs.

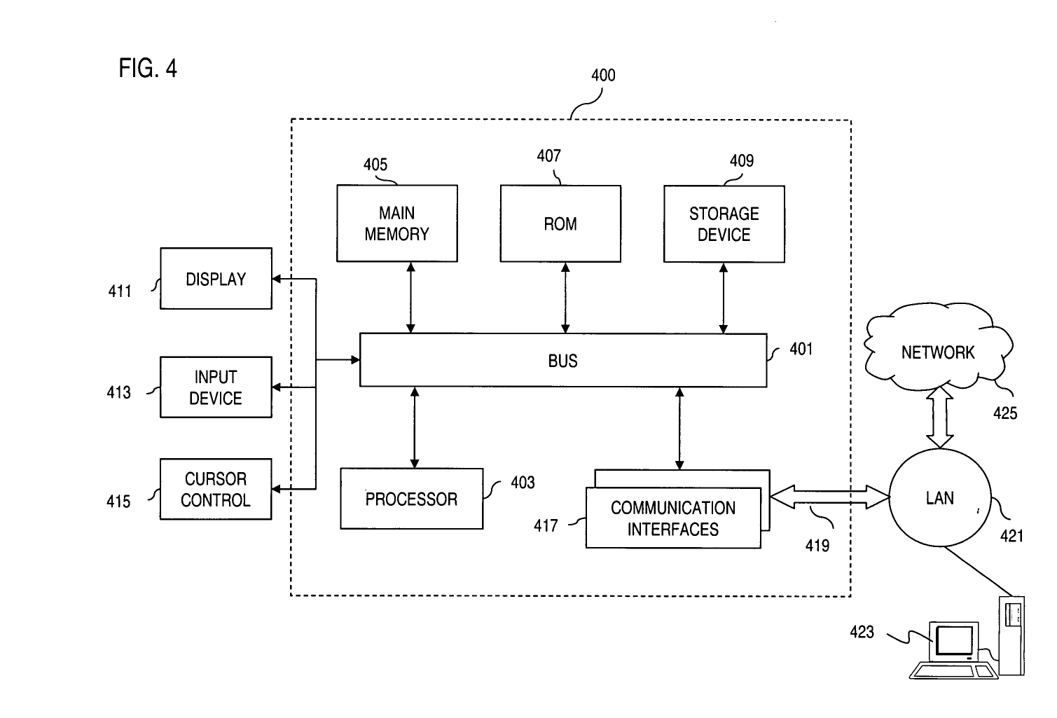

In addition to the standard storage service, the media 105 can be made available via the Internet for an additional fee. Under this arrangement, the deposited media 105 can be stored in the database 119 of the tracking system 115, which can interface a web server (not shown) that is accessible by the Internet (e.g., network 425 of FIG. 4).

FIG. 3 is a flowchart of a process for a consumer-level user to retrieve the stored electronic media in the system of FIG. 1. The customer 109 now decides to retrieve the media 105 that was previously deposited, and arrives at the storage provider location 101 (e.g., retailer), per step 301. The customer 109 hands over the card previously received or simply provides the unique identifier to the agent 111, as in step 305. In step 307, the agent 111 inputs the unique identifier into the tracking system 115, which outputs the location information (i.e., the second barcode) of the media 105 within the storage facility 113 (step 309). The agent 111, as in steps 311 and 313, then retrieves the stored media for the customer 109.

The computing systems of FIG. 1 can be implemented using a wide variety of computers, such as personal computers, workstations, etc.; one example is shown in FIG. 4.

### Hardware Overview

FIG. 4 illustrates a computer system 400 upon which an embodiment according to the present invention can be implemented. The computer system 400 includes a bus 401 or other communication mechanism for communicating information and a processor 403 coupled to the bus 401 for processing information. The computer system 400 also includes main memory 405, such as a random access memory (RAM) or other dynamic storage device, coupled to the bus 401 for storing information and instructions to be executed by the processor 403. Main memory 405 can also be used for storing temporary variables or other intermediate information during execution of instructions by the processor 403. The computer system 400 may further include a read only memory (ROM) 407 or other static storage device coupled to the bus 401 for storing static information and instructions for the processor 403. A storage device 409, such as a magnetic disk or optical disk, is coupled to the bus 401 for persistently storing information and instructions.

The computer system 400 may be coupled via the bus 401 to a display 411, such as a cathode ray tube (CRT), liquid crystal display, active matrix display, or plasma display, for displaying information to a computer user. An input device 413, such as a keyboard including alphanumeric and other keys, is coupled to the bus 401 for communicating information and command selections to the processor 403. Another type of user input device is a cursor control 415, such as a mouse, a trackball, or cursor direction keys, for communicating direction information and command selections to the processor 403 and for controlling cursor movement on the display 411.

According to one embodiment of the invention, data collection of the customer 109 and tracking of the electronic media 105 is provided by the computer system 400 in response to the processor 403 executing an arrangement of instructions contained in main memory 405. Such instructions can be read into main memory 405 from another computer-readable medium, such as the storage device 409. Execution of the arrangement of instructions contained in main memory 405 causes the processor 403 to perform the process steps described herein. One or more processors in a multi-processing arrangement may also be employed to execute the instructions contained in main memory 405. In alternative embodiments, hard-wired circuitry may be used in place of or in combination with software instructions to implement the embodiment of the present invention. In another example, reconfigurable hardware such as Field Programmable Gate Arrays (FPGAs) can be used, in which the functionality and connection topology of its logic gates are customizable at run-time, typically by programming memory look up tables. Thus, embodiments of the present invention are not limited to any specific combination of hardware circuitry and software.

The computer system 400 also includes a communication interface 417 coupled to bus 401. The communication interface 417 provides a two-way data communication coupling to a network link 419 connected to a local network 421. For example, the communication interface 417 may be a digital subscriber line (DSL) card or modem, an integrated services digital network (ISDN) card, a cable modem, a telephone modem, or any other communication interface to provide a data communication connection to a corresponding type of communication line. As another example, communication interface 417 may be a local area network (LAN) card (e.g. for Ethernet™ or an Asynchronous Transfer Model (ATM) network) to provide a data communication connection to a compatible LAN. Wireless links can also be implemented. In any such implementation, communication interface 417 sends and receives electrical, electromagnetic, or optical signals that carry digital data streams representing various types of information. Further, the communication interface 417 can include peripheral interface devices, such as a Universal Serial Bus (USB) interface, a PCMCIA (Personal Computer Memory Card International Association) interface, etc. Although a single communication interface 417 is depicted in FIG. 4, multiple communication interfaces can also be employed.

The network link 419 typically provides data communication through one or more networks to other data devices. For example, the network link 419 may provide a connection through local network 421 to a host computer 423, which has connectivity to a network 425 (e.g. a wide area network (WAN) or the global packet data communication network now commonly referred to as the “Internet”) or to data equipment operated by a service provider. The local network 421 and the network 425 both use electrical, electromagnetic, or optical signals to convey information and instructions. The signals through the various networks and the signals on the network link 419 and through the communication interface 417, which communicate digital data with the computer system 400, are exemplary forms of carrier waves bearing the information and instructions.

The computer system 400 can send messages and receive data, including program code, through the network(s), the network link 419, and the communication interface 417. In the Internet example, a server (not shown) might transmit requested code belonging to an application program for implementing an embodiment of the present invention through the network 425, the local network 421 and the communication interface 417. The processor 403 may execute the transmitted code while being received and/or store the code in the storage device 409, or other non-volatile storage for later execution. In this manner, the computer system 400 may obtain application code in the form of a carrier wave.

The term “computer-readable medium” as used herein refers to any medium that participates in providing instructions to the processor 405 for execution. Such a medium may take many forms, including but not limited to non-volatile media, volatile media, and transmission media. Non-volatile media include, for example, optical or magnetic disks, such as the storage device 409. Volatile media include dynamic memory, such as main memory 405. Transmission media include coaxial cables, copper wire and fiber optics, including the wires that comprise the bus 401. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the present invention may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

### Conclusion

Accordingly, an approach is disclosed for providing consumer-level data off-site storage that is convenient and cost-effective, while supporting a new source of revenue of existing retailers.

While the present invention has been described in connection with a number of embodiments and implementations, the present invention is not so limited but covers various obvious modifications and equivalent arrangements, which fall within the purview of the appended claims.

What is claimed is:

1. A method for providing storage services at a retailer facility that sells consumer products, the method comprising the steps of:
receiving a physical media from a consumer, wherein the physical media stores content imparted by the consumer;
generating a first identifier for identifying the consumer, and a second identifier for specifying location of the physical media within the retailer facility;
storing the physical media at the location according to the second identifier; and
charging the consumer for storage of the physical media.

2. A method according to claim 1, wherein the physical media includes one of a compact disc, a ZIP disk, a hard drive, a diskette, a flash memory card, and other non-volatile storage device.

3. A method according to claim 1, further comprising the steps of:
generating a plurality of labels corresponding to the first identifier and the second identifier;
affixing one of the labels to the physical media and another one of the labels to a container housing the physical media; and
outputting a receipt for the consumer, the receipt containing the identifiers.

4. A method according to claim 3, wherein the identifiers are converted to a barcode.

5. A method according to claim 3, wherein the container is sized to maximize utilization of storage space within the retailer facility.

6. A method according to claim 1, further comprising the step of:
computing a fee to charge the consumer based on one of frequency of pick-up and drop-off of the physical media and dimensions of the physical media.

7. A tracking system for supporting storage services at a retail establishment that includes a storage facility, the system comprising:
a processor configured, in response to receiving a physical media from a consumer, to generate a first identifier for identifying the consumer, and a second identifier for specifying location of the physical media within the retailer facility; and
a database configured to store the generated identifiers,
wherein the storage facility stores the physical media at the location according to the second identifier, and the consumer is charged for storage of the physical media.

8. A system according to claim 7, wherein the physical media includes one of a compact disc, a ZIP disk, a hard drive, a diskette, a flash memory card, and other non-volatile storage device.

9. A system according to claim 7, wherein the processor generates a plurality of labels corresponding to the first identifier and the second identifier, one of the labels being affixed to the physical media and another one of the labels being affixed to a container housing the physical media, the processor further outputting a receipt for the consumer, the receipt containing the identifiers.

10. A system according to claim 9, wherein the identifiers are converted to a barcode.

11. A system according to claim 9, wherein the container is sized to maximize utilization of the storage facility.

12. A system according to claim 7, wherein the processor determines a fee to charge the consumer based on one of frequency of pick-up and drop-off of the physical media and dimensions of the physical media.

13. A computer-readable medium carrying one or more sequences of one or more instructions for providing storage services at a retailer facility that sells consumer products, the one or more sequences of one or more instructions including instructions which, when executed by one or more processors, cause the one or more processors to perform the steps of:
receiving a physical media from a consumer, wherein the physical media stores content imparted by the consumer;
generating a first identifier for identifying the consumer, and a second identifier for specifying location of the physical media within the retailer facility;
storing the physical media at the location according to the second identifier; and
charging the consumer for storage of the physical media.

14. A computer-readable medium according to claim 13, wherein the physical media includes one of a compact disc, a ZIP disk, a hard drive, a diskette, a flash memory card, and other non-volatile storage device.

15. A computer-readable medium according to claim 13, the computer-readable medium further including instructions for causing the one or more processors to perform the step of:
generating a plurality of labels corresponding to the first identifier and the second identifier;
affixing one of the labels to the physical media and another one of the labels to a container housing the physical media; and
outputting a receipt for the consumer, the receipt containing the identifiers.

16. A computer-readable medium according to claim 15, wherein the identifiers are converted to a barcode.

17. A computer-readable medium according to claim 15, wherein the retailer facility includes shelving, and the container is sized to maximize utilization of storage space within the retailer facility.

18. A computer-readable medium according to claim 13, the computer-readable medium further including instructions for causing the one or more processors to perform the step of:
computing a fee to charge the consumer based on one of frequency of pick-up and drop-off of the physical media and dimensions of the physical media.
